(19) United States
(12) Patent Application Publication
(10) Pub. No.: US 2008/0087444 A1
(43) Pub. Date: Apr. 17, 2008

(54) New technique for fire fighting-large scale open fires

(76) Inventor: Jerry M. Held, Cottonwood, AZ (US)

Correspondence Address: JERRY M. HELD, P. O. BOX 33140, SANTA FE, NM, 87594, US

(21) Appl. No.: 11/546,272

(22) Filed: Oct. 12, 2006

(51) Int. Cl. A62C 8/00

(52) U.S. Cl. 169/36; 169/53

(57) ABSTRACT

An invention is presented that will usher in a new and markedly improved era of open, large scale fire fighting. ‘The Invention’ places a CAFS (compressed air foam system) into the fuselage of a helicopter or fixed-wing plane. The CAFS then generates high volumes of effective fire-extinguishing and preventive micellar-foam solution at the attack point of the fire itself rather than refilling at a remote base. It accesses ater contained in a helicopter's Bambi Bucket and refills from a fixed wing plane or other water containing reservoir. The foam solution is then packaged into balloons, made of fire retardant and bio-friendly material, that are accurately and rapidly dropped upon the target fire.

‘The Invention” therefore utilizes and adapts currently available equipment, personnel, and fire-fighting technology to allow a simple, rapid, effective and drastically cost-saving means of extinguishing open fires. All communities and businesses will be able to protect their communities and environment and the lives of their animals and citizens.

### BACKGROUND OF THE INVENTION

Aerial firefighting is the most effective and, for all practical purposes, the only method available for combating large scale, open fires, or those that occur in mountains, forests, brush, or in open range. The societal costs associated with such fires are astronomical in terms of money, property damage and destruction, environmental degradation, and human and animal death, injury and dislocation.

Methods used for fighting open fires by air have improved only incrementally since the advent of aviation, and the fact is that most open fires are extinguished not by human intervention at all, but by natural forces such as rain, shifting winds, and the complete consumption of available fuel. The primary reason for this limited success in fighting open fires by air is that aircraft—whether fixed wing or, more commonly, helicopters—are limited in the amount of water or chemical retardants that they can carry, and are further limited in their ability to accurately and effectively deliver those retardants under the extreme conditions that commonly prevail in these kinds of fires.

The evolution of aerial firefighting has included developments such as dropping water or chemical retardants from aerial tankers or specially-designed helicopters, dispensing retardants from helicopter-towed, refillable fabric ‘buckets,’ and injecting foam-producing chemicals into water-filled containers for spraying over the target area. Examples of all of these techniques can be found in the product line of industry-leader SEI Industries, Ltd. (www.sei.com) including their Bambi Bucket® and Sacksafoam™ products. Although these products reflect the current state of the art in aerial firefighting, all are limited both in their ability to bring sufficient volumes of retardant to the task and in their ability to deliver retardant accurately and effectively from high altitudes in high winds over large, hot fires.

The presented invention seeks to rectify these endemic shortcomings by exponentially increasing the volume of fire retardant material that an ordinary helicopter or fixed-wing aircraft can deliver, and by enabling a huge volume of retardant to be delivered accurately and effectively in even the most extreme wildfire conditions.

### BRIEF SUMMARY OF THE INVENTION

The object of the invention is to improve aerial firefighting capability by maximizing the volume of fire retardant material that an ordinary helicopter or fixed-wing aircraft can deliver to an open-area fire while optimizing the accurate delivery of that material under even the most extreme and adverse conditions. These and other valuable objects are achieved by utilizing an airborne compressed air foam generator to produce, from a limited water supply, large volumes of micellar-foam solution, and by employing an automated balloon-like delivery system to rapidly and accurately disburse the solution to its target over a large open fire.

### BRIEF DESCRIPTION OF THE SEVERAL VIEWS OF THE DRAWINGS

FIG. 1 is a schematic illustration of the components of the firefighting apparatus, consisting of (A) a ‘pumpkin,’ or water reservoir, which can be ground-based aquatic, ground-based terrestrial, or a supplier-aircraft, (B) a ‘bambi bucket,’ which is a large water-carrying receptacle attached to and towed beneath the firefighting aircraft, (C) a ‘foam generator,’ which can be a commercially-available compressed-air foam system, or CAFS, that is placed within the firefighting aircraft, (D) a ‘transducer,’ representing the programmed electronic control mechanism that initiates the foam generation and delivery sequence, (E) a ‘balloon transport,’ similar in operation to a soda vending machine, which houses and sequentially presents the female portions of the delivery receptacles (“balloons”) to the nozzle of the foam generator, and (F) an ‘electronic arm,’ to which the nozzle of the foam generator is mounted, which inserts into the balloons, pivots in order to move the balloons to a location outside of the aircraft fuselage, then fills and release the balloons.

FIG. 2 is a flow chart illustrating the process of converting water into foam, which is then injected into balloon-like receptacles, by means of a contractible nozzle mounted on an electronic arm, before being released from the firefighting aircraft.

FIG. 3 is an illustration of one of several possible configurations of the pivoting electronic arm and mounted nozzle that connects with, relocates, fills, and then releases the balloons.

FIG. 4 is an illustration of one of several possible configurations of the male nozzle of the foam generator and the female opening of a balloon, demonstrating expansion of the nozzle head once inserted.

FIG. 5 illustrates the components and function of one of several possible configurations of the delivery balloon.

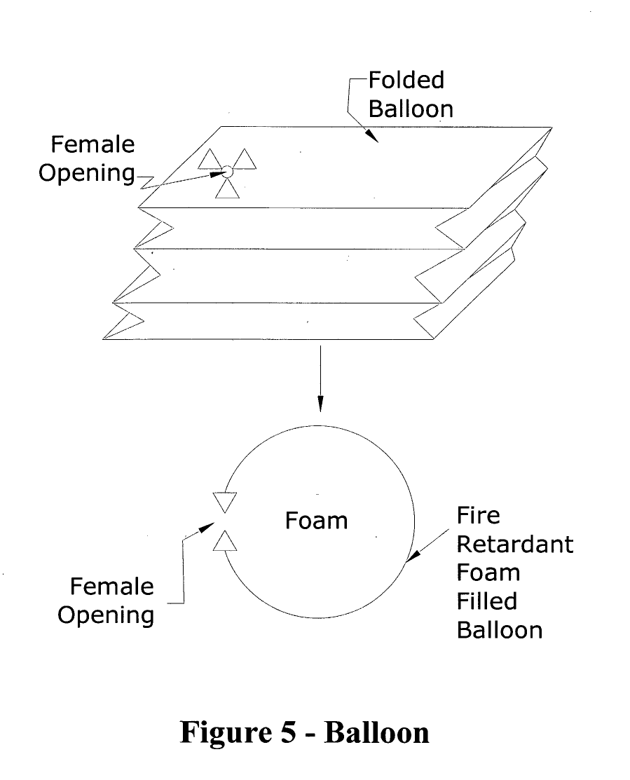

### DETAILED DESCRIPTION OF THE INVENTION

The invention is a self-contained, fully integrated mechanism by which an aircraft pilot can, while airborne, convert a relatively small volume of water into a relatively large volume of fire retardant foam in situ, inject that foam into balloon-like receptacles, and accurately deliver those receptacles under even the most extreme conditions where needed in order to extinguish an open-area fire.

This result is achieved by pumping water from an airborne source through a compressed-air foam generator housed in the aircraft's fuselage. The aerated foam is then disbursed from the aircraft by rapidly injecting it into balloon-like receptacles that are delivered automatically and accurately to the target fire by means of a mechanical arm.

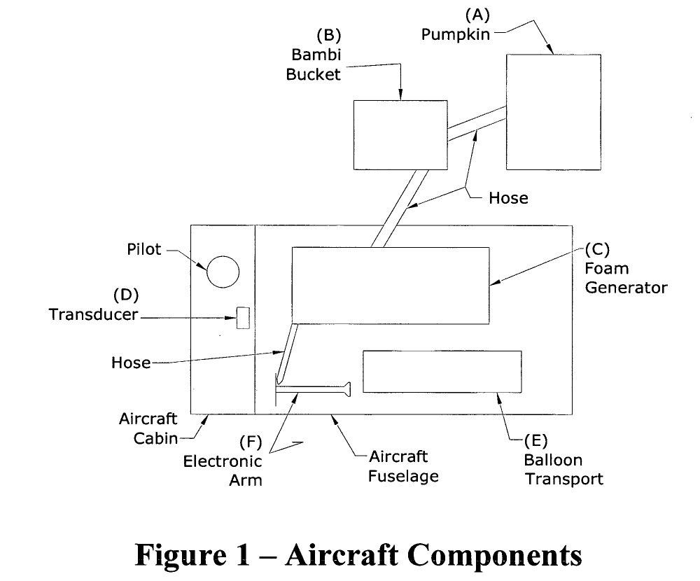

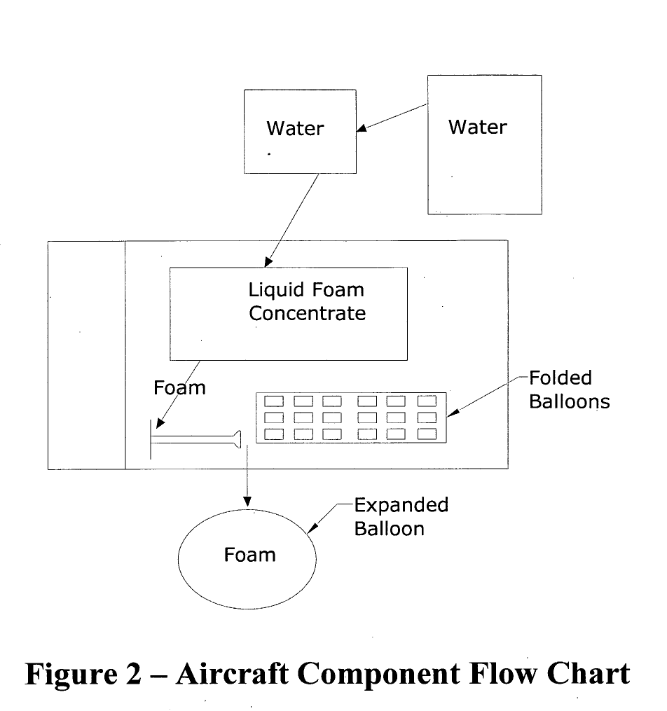

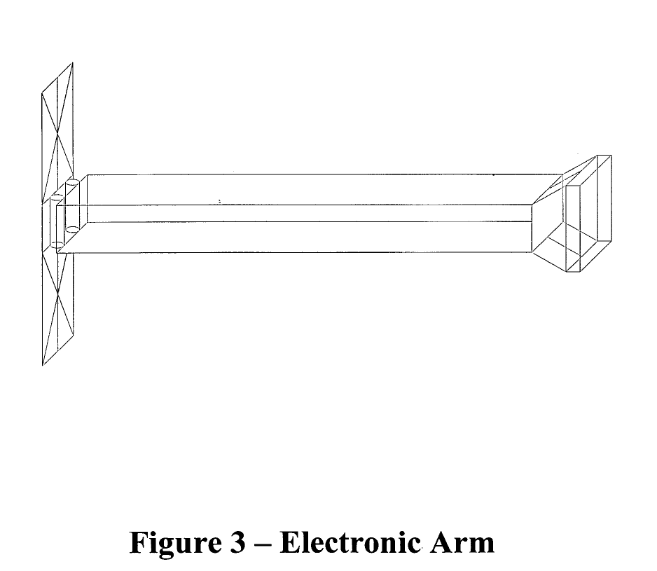

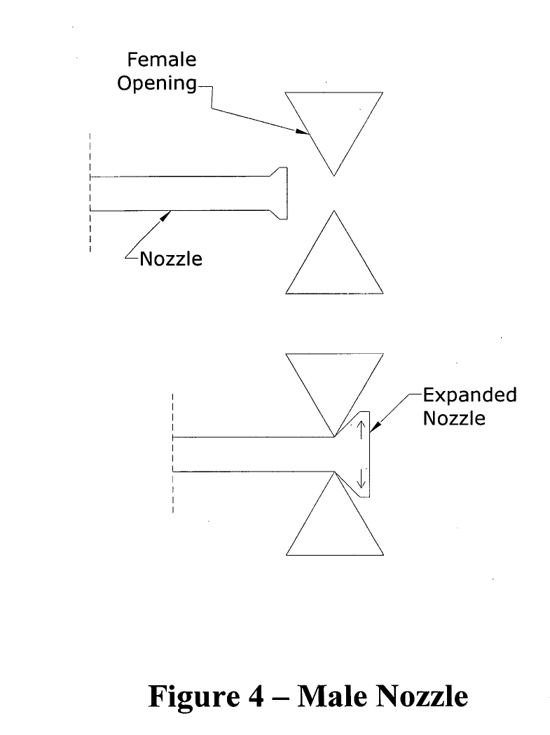

The preferred embodiment of the invention begins with a water source exterior to the firefighting aircraft, which can either be terrestrial (a lake, reservoir, tank or fire truck, for but a few examples) or airborne (such as a tanker aircraft). [FIG. 1 (A).] Water from this exterior source is then stored in the firefighting aircraft, as in the case of a helicopter towing a ‘bambi bucket’ or similar large (500 to 800-gallon) receptacle, and is flown to a location over the blaze. [FIG. 1 (B).] At the desired location, the pilot activates the transducer [FIG. 1 (D)], which initiates the following mechanical sequence: First, the water is pumped through a compressed-air foam generator [FIGS. 1 (C) and 2] housed in the aircraft's fuselage, which is capable of aerating the combined water and a concentrated liquid foam, multiplying the water volume at a ratio of approximately 30:1. Next, a retractable nozzle mounted at the end of a pivoting mechanical arm [FIGS. 1 (F) and 3] connects into the female portion of a weighted, expandable balloon-like receptacle [FIG. 4], which is housed in an automated transport mechanism [FIGS. 1 (E) and 2] that presents the balloon-like receptacles to the nozzle in rapid sequence. The balloon-like receptacle is then swung outside the aircraft, injected with foam, and released by the pivoting mechanical arm. [FIGS. 1 (F) and 3]. The balloon-like receptacles thus released drop from the aircraft and explode upon impact with the ground, or upon contact with the fire.

The invention is portable and re-usable, and can be installed in virtually any aircraft. Each of its components either already exists or can easily be adapted from existing technologies. The use of weighted, balloon-like receptacles for delivery of the retardant material is vastly superior to simply spraying or dumping retardant, which results in wide, inaccurate dispersal, particularly in large, hot fires that generate high winds and preclude low-elevation overflights. The use of an aerated foam solution is far superior to either water or non-aerated foam, as it allows for better dispersal of water as a cooling material, decreased surface beading of water, better penetration into kindling, superior adhesion, and overall better cooling and insulation from surface air. The invention will allow a single aircraft with access to a water source to extinguish even the largest, hottest and least accessible fires in a matter of hours, rather than the days or weeks required by existing firefighting methods.

1-22. (canceled)

23. A mechanized aerial firefighting system that utilizes an aerated foam retardant.

24. The device of claim 23 wherein the source of water for the aerated foam retardant is an airborne tank, bucket or similar water-towing receptacle.

25. The device of claim 23 wherein the aerated foam retardant is produced by means of an onboard compressed-air generator.

26. The device of claim 23 wherein the aerated foam retardant is disbursed directly over an open fire.

27. The device of claim 23 wherein the aerated foam retardant is injected into expandable receptacles, which are then dropped over an open fire.

28. The device of claim 27 wherein the expandable receptacles are elastic, balloon-like vessels.

29. The device of claim 27 wherein the receptacles expand in accordion-like fashion.

30. The device of claim 27 wherein the expandable receptacles are made of or are coated with a fire-retardant material.

31. The device of claim 27 wherein the expandable receptacles are made of biodegradable material.

32. The device of claim 27 wherein the expandable receptacles are weighted.

33. The device of claim 27 wherein the mechanism for injecting the expandable receptacles is a nozzel attached to a hose that is connected to the onboard compressed-air generator.

34. The device of claim 27 wherein the expandable receptacles are housed in a mechanical device that rapidly presents them for injection with aerated foam retardant.

35. The device of claim 27 wherein the expandable receptacles, once filled with aerated foam retardant, are dropped from the aircraft by means of a mechanical arm.

36. The device of claim 27 wherein the expandable receptacles, once filled with aerated foam retardant, are dropped from the aircraft by means of compressed air or other similar propellant.

37. An aerial firefighting system that disperses fire retardant by means of contained vessels.

38. The method of claim 37 wherein the contained vessels are inelastic receptacles, including bags, boxes, balls or other containers.

39. The method of claim 37 wherein the contained vessels are elastic, balloon-like receptacles.

40. The method of claim 37 wherein the contained vessels are expandable, accordion-like receptacles.

41. The method of claim 37 wherein the contained vessels are made of biodegradable material.

42. The method of claim 37 wherein the contained vessels are made of or are coated with a fire-retardant material.

43. The method of claim 37 wherein the contained vessels are weighted.
